(19) United States
(12) Patent Application Publication
(10) Pub. No.: US 2012/0085479 A1
(43) Pub. Date: Apr. 12, 2012

(54) MANUFACTURING METHOD FOR PACKAGING BAG WITH ZIPPER TAPE AND MANUFACTURING APPARATUS THEREFOR

(75) Inventor: Shuichi Goto, Tokyo (JP)

(73) Assignee: IDEMITSU UNITECH CO., LTD., Chuo-ku, Tokyo (JP)

(21) Appl. No.: 13/377,670

(22) PCT Filed: Jun. 2, 2010
(86) PCT No.: PCT/JP2010/059311

§ 371 Date: Dec. 12, 2011

(30) Foreign Application Priority Data
Jun. 12, 2009 (JP) 2009-141609

(51) Int. Cl. B32B 37/14; B32B 38/10; B32B 38/04; B32B 37/02

(52) U.S. Cl. 156/66; 156/538

(57) ABSTRACT

A zipper tape member having a male engagement portion and a female engagement portion formed on a surface of an elongated belt-like tape is pulled out, and is punched and removed at a portion corresponding to the male engagement portion and a portion corresponding to the female engagement portion at predetermined intervals. The zipper tape member is cut between the male engagement portion and the female engagement portion by a cutting member to be separated into a male belt-like member and a female belt-like member. The male belt-like member and the female belt-like member are heat-sealed to a base film, and a packaging bag is formed by a bag-manufacturing device. This arrangement is unlikely to cause a length difference or a tension difference between the male belt-like member and the female belt-like member, so that the zipper tape can be heat-sealed without any crease or adhesion failure.

### TECHNICAL FIELD

The present invention relates to a method of manufacturing a zipper packaging bag provided with a zipper tape and a manufacturing device of the same.

### BACKGROUND ART

A zipper packaging bag provided with a zipper tape has been used in many fields such as foods, medical products and groceries. A typical zipper tape includes male member and female member engageable with each other.

There have been known a variety of methods of manufacturing such a zipper packaging bag (see Patent Literatures 1 to 3).

According to Patent Literature 1, a zipper tape having mutually engageable male member and female member formed side by side on a sheet of film is fed while being folded in half to engage the male member and the female member with each other. Both longitudinal edges of a bag body film are pulled closer to each other as if palms are put together so that the bag body film is in a cylindrical shape. Both edges of the folded zipper tape and both edges of the bag body film in a cylindrical shape are superposed on each other to be adhered together, and then the cylindrical body is sealed and cut in an orthogonal direction at predetermined intervals, thereby manufacturing a zipper packaging bag.

According to Patent Literature 2, a zipper tape includes a male tape provided with a male member and a female tape provided with a female member. While the male member and female member are engaged with each other, the zipper tape is fed between two superposed sheets of bag body film to be adhered thereto. The bag body film is cut after being heat-sealed in a cylindrical shape and being further heat-sealed in a direction orthogonal to a feeding direction at predetermined intervals, thereby manufacturing a zipper packaging bag.

According to Patent Literature 3, as shown in FIG. 16 herein, both longitudinal edges of a material sheet 610 are put together such that the material sheet 610 is in a cylindrical shape, and a zipper tape 601 provided by engaging a pair of tapes having male member and female member with each other is fed between the longitudinal edges of the material sheet 610 to be adhered thereto. The material sheet 610 in a cylindrical shape with the zipper tape 601 adhered thereto is then heat-sealed and cut in a direction orthogonal to a feeding direction at predetermined intervals, thereby manufacturing a zipper packaging bag 620.

### CITATION LIST

### Patent Literatures

Patent Literature 1 JP-A-63-191705

Patent Literature 1 JP-A-2003-276099

Patent Literature 3 JP-A-6-32305

### SUMMARY OF THE INVENTION

### Problems to be Solved by the Invention

When a single zipper tape is folded in half for engagement between the male member and female member and then the folded zipper tape is adhered to both edges of the bag body tape in a cylindrical shape as disclosed in Patent Literature 1, in order to unseal the resulting packaging bag, an additional arrangement is required to cut the bag body film in such a manner as to separate the male member and female member from each other. Additionally, the male member and the female member of the zipper tape need to be adhered to the bag body film while being engageable with each other. In view of the above, a process of manufacturing a zipper packaging bag is likely to be complicated.

In order to adhere the already-engaged zipper tape as disclosed in Patent Literatures 2 and 3 to a bag body film, the already-engaged zipper tape 601 is typically wound on a magazine 602 and fed therefrom as disclosed in Patent Literature 3 (see FIG. 16 herein). However, a radius difference between the inner circumference and the outer circumference of a roll of the zipper tape 601 is likely to result in a length difference in the feeding direction when the zipper tape 601 is fed. When the zipper tape 601 with a length difference is adhered to the material sheet 610, there may be some problems caused, such as creases on the material sheet 610 and adhesion failure of the zipper tape 601.

Alternatively, as disclosed in Patent Literature 3 (see FIG. 17 herein), a male member 605 (606) and a female member 606 (605) may be separately fed and adhered to the material sheet 610 without being engaged with each other to form the zipper tape 601. With this arrangement, however, since a tension applied to the male member 605 (606) and a tension applied to the female member 606 (605) are different from each other, when the male member 605 (606) and the female member 606 (605) are adhered to the material sheet 610, there may be some problems caused, such as creases formed on the material sheet 610 and adhesion failure.

An object of the invention is to provide a manufacturing method of a zipper packaging bag provided with a zipper tape and a manufacturing device of the same, the manufacturing method and manufacturing device being capable of easily manufacturing the zipper packaging bag without problems such as creases and adhesion failure.

### Means for Solving the Problems

A method according to an aspect of the invention is for manufacturing a zipper packaging bag, the zipper packaging bag being manufactured by adhering to a packaging bag film a zipper tape including a pair of male engagement portion and female engagement portion that are detachably engageable with each other to provide an engagement portion, including: feeding a zipper tape member comprising an elongated belt-like tape on which the pair of male engagement portion and female engagement portion are formed along a longitudinal direction of the zipper tape member; separating the fed zipper tape member in a width direction of the zipper tape member into the male engagement portion and the female engagement portion to provide a male tape forming the male engagement portion and a female tape forming the female engagement portion; and adhering the male tape and the female tape to the packaging bag film.

In the above aspect of the invention, it is preferable that the fed zipper tape member is separated using a cutting member. An example of the cutting member is a cutting blade that is brought into contact with one or both of the surfaces of the zipper tape to cut the zipper tape.

In the above aspect of the invention, it is preferable that the zipper tape member comprises at least one of a thin portion formed between the male engagement portion and the female engagement portion along the longitudinal direction of the zipper tape member and a perforated portion in a shape of a dotted cut line, and the zipper tape member is separated by applying opposite tensions in a thickness direction of the zipper tape member to both sides of the zipper tape member relative to the longitudinal direction of the zipper tape member, respectively, so that the zipper tape member is split at least at one of the thin portion and the perforated portion.

In the above aspect of the invention, it is preferable that the method further includes: punching the zipper tape member or the male tape and the female tape at predetermined intervals in a feeding direction of the zipper tape member at least at a position corresponding to the male engagement portion and a position corresponding to the female engagement portion. The punching may be performed before or after the separating of the zipper tape. However, in consideration of, in particular, accuracy in the punching intervals of the male tape and female tape and manufacturing efficiency, the punching is preferably performed before the separating of the zipper tape.

In the above aspect of the invention, it is preferable that the male tape and the female tape are adhered to the packaging bag film while the male engagement portion and the female engagement portion are engaged with each other.

A manufacturing device according to another aspect of the invention is for manufacturing a zipper packaging bag, the zipper packaging bag being manufactured by adhering to a packaging bag film a zipper tape comprising a pair of male engagement portion and female engagement portion that are detachably engageable with each other to provide an engagement portion, the manufacturing device including: a tape feeding unit configured to feed a zipper tape member at one end of the zipper tape member in a longitudinal direction of the zipper tape member, the zipper tape member comprising an elongated belt-like tape on which the pair of male engagement portion and female engagement portion are formed along the longitudinal direction; a separating unit configured to separate the fed zipper tape member in a width direction of the zipper tape member into the male engagement portion and the female engagement portion to provide a male tape forming the male engagement portion and a female tape forming the female engagement portion; and an adhering unit configured to adhere the male tape and the female tape to the packaging bag film.

With the above arrangement, before being adhered to the packaging bag film, the zipper tape member, on which a pair of male engagement portion and female engagement portion are formed, is separated into the male tape and the female tape, so that the male tape and the female tape can be adhered to the packaging bag film without a length difference or a tension difference therebetween. Thus, an engageable and openable zipper packaging bag can be easily manufactured without problems such as creases formed on the packaging bag film and adhesion failure of the zipper tape.

### BRIEF DESCRIPTION OF DRAWINGS

FIG. 1 is a plan view showing a zipper packaging bag according to a first exemplary embodiment of the invention.

FIG. 2 is a cross-sectional view showing the zipper packaging bag according to the first exemplary embodiment.

FIG. 3 is a perspective view showing a manufacturing device of a zipper packaging bag according to the first exemplary embodiment.

FIG. 4 is a perspective view showing a cut formed in a zipper tape member according to the first exemplary embodiment.

FIG. 5 is a perspective view showing a manufacturing device of a zipper packaging bag according to a second exemplary embodiment of the invention.

FIG. 6 is a perspective view showing a cut formed in a zipper tape member according to the second exemplary embodiment.

FIG. 7 is a plan view showing a zipper packaging bag according to a third exemplary embodiment of the invention.

FIG. 8 is a cross-sectional view showing the zipper packaging bag according to the third exemplary embodiment.

FIG. 9 is a perspective view showing a manufacturing device of a zipper packaging bag according to the third exemplary embodiment.

FIG. 10 is a cross-sectional view showing a state where a zipper tape according to the third exemplary embodiment is heat-sealed to a base film.

FIG. 11 is a cross-sectional view showing a zipper packaging bag according to another example of the invention.

FIG. 12 is a cross-sectional view showing a state where a zipper tape is heat-sealed to a base film in manufacturing the zipper packaging bag shown in FIG. 11.

FIG. 13 is a plan view showing a zipper packaging bag according to a fourth exemplary embodiment of the invention.

FIG. 14 is a perspective view showing a manufacturing device of the zipper packaging bag according to the fourth exemplary embodiment of the invention.

FIG. 15 is a perspective view showing a zipper tape according to another example of the invention.

FIG. 16 is a perspective view showing a typical manufacturing device of a zipper packaging bag in relation to the invention.

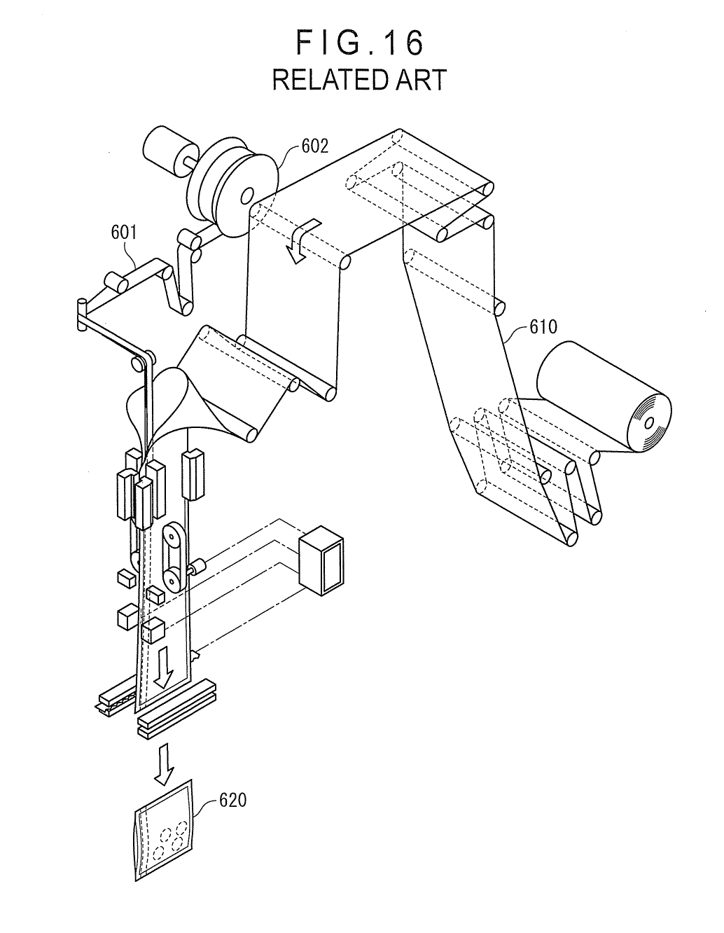

FIG. 17 is a perspective view showing another typical manufacturing device of a zipper packaging bag in relation to the invention.

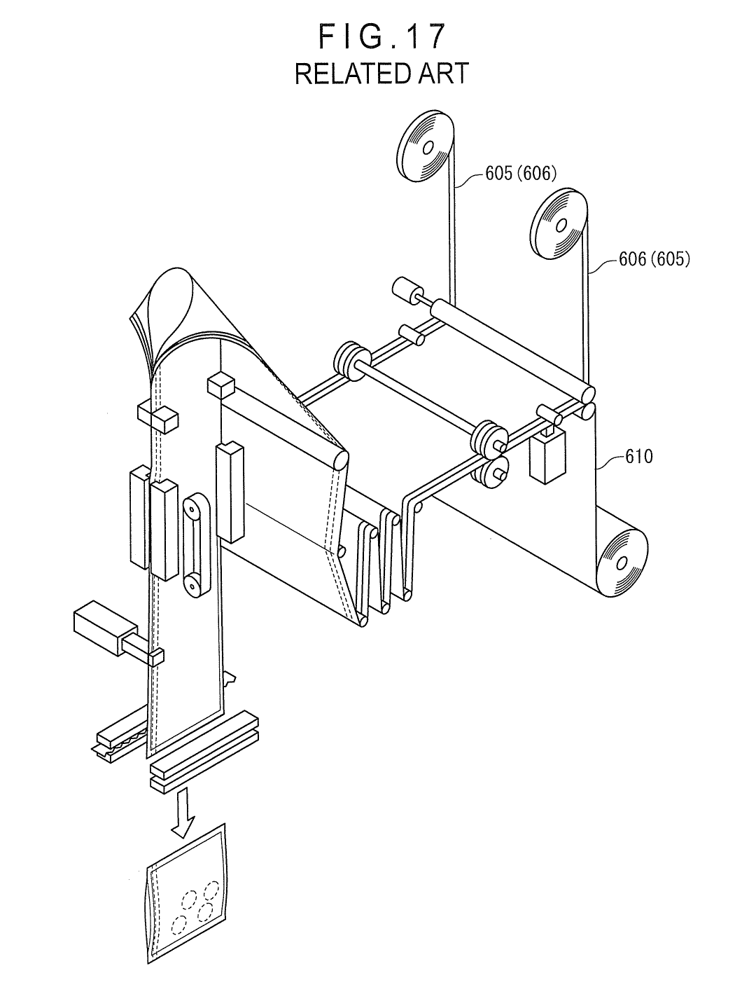

### DESCRIPTION OF EXEMPLARY EMBODIMENTS

### First Exemplary Embodiment

A first exemplary embodiment of the invention will be described below with reference to the attached drawings.

In the first exemplary embodiment, a zipper packaging bag (hereinafter, abbreviated as a “packaging bag”) is exemplified by a packaging bag for packaging various articles such as foods, medicines, medical products and groceries.

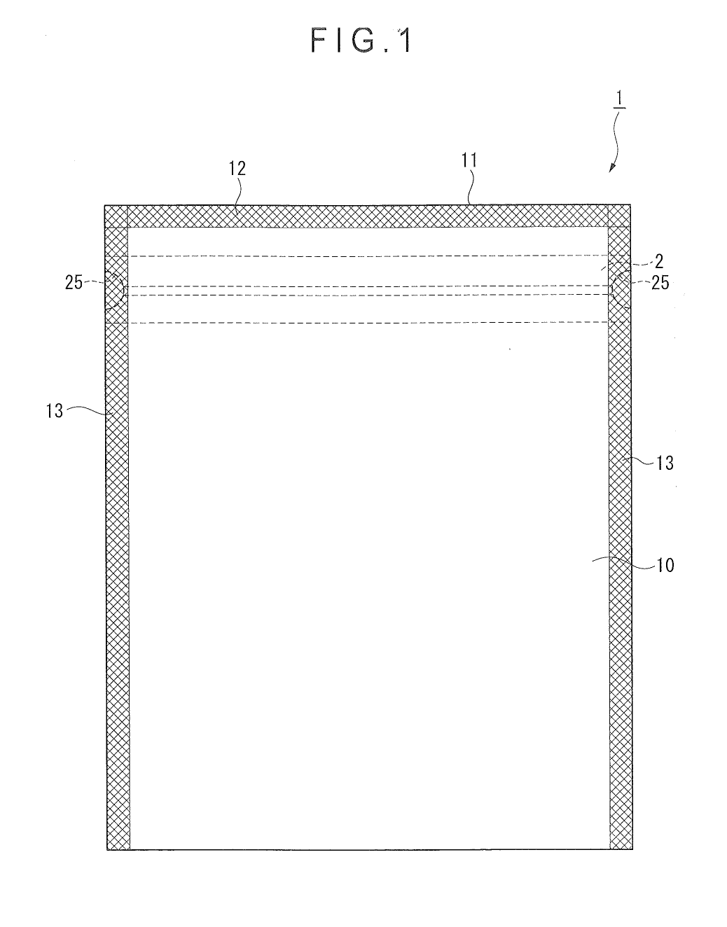

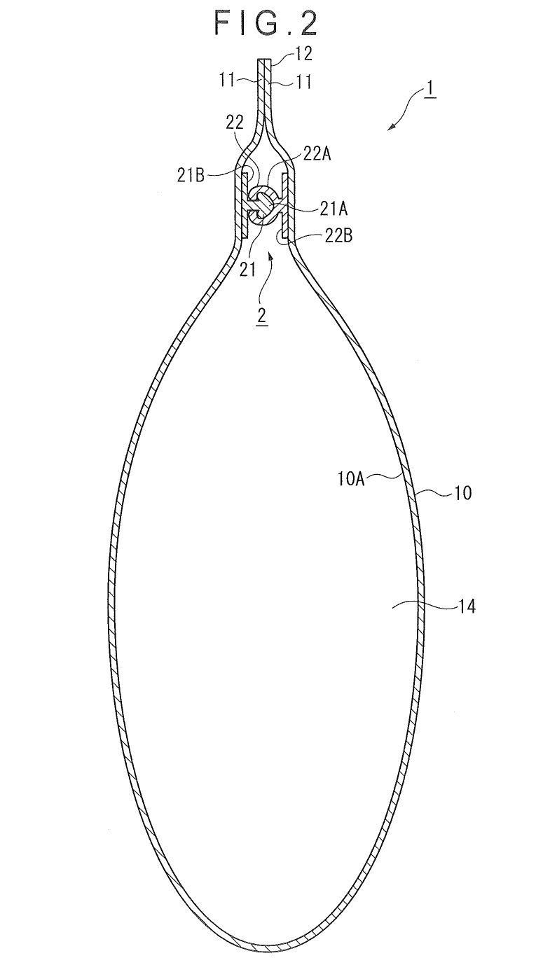

FIG. 1 is a plan view showing a packaging bag according to the first exemplary embodiment. FIG. 2 is a cross-sectional view showing the packaging bag according to the first exemplary embodiment.

Arrangement of Packaging Bag

As shown in FIGS. 1 and 2, a packaging bag 1 includes a sheet of base film 10 (packaging bag film), a male belt-like member 21 (male tape) including a male engagement portion 21A, and a female belt-like member 22 (female tape) including a female engagement portion 22A, the male belt-like member 21 and female belt-like member 22 being adhered to the base film 10. The male belt-like member 21 and the female belt-like member 22 provide a zipper tape 2.

The base film 10 includes a top seal portion 12 in which first and second base ends 11 are superposed on each other.

Side seal portions 13 are provided by heat-sealing both side edge portions of the base film 10. The male belt-like member 21 and the female belt-like member 22 extend between the side seal portions 13.

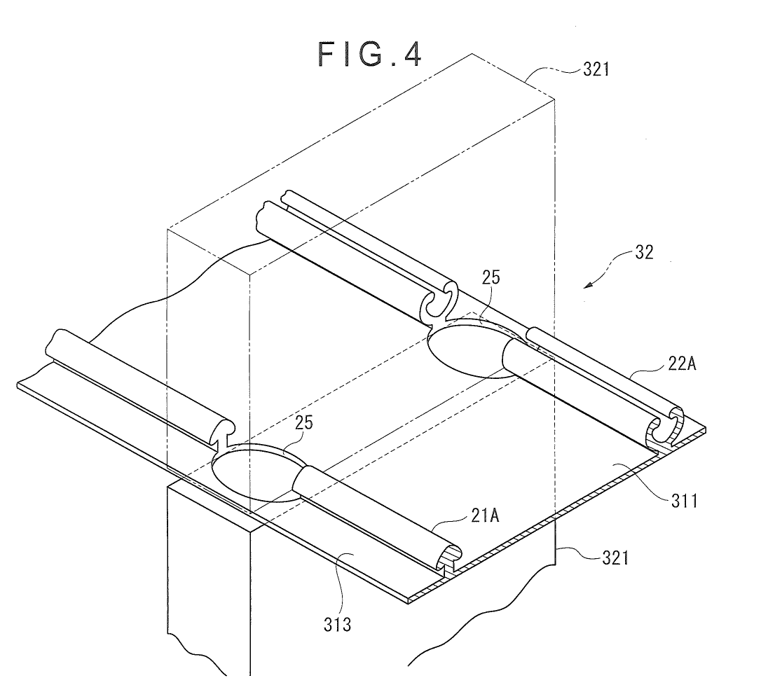

As shown in FIG. 4, a cut 25 is provided to the male belt-like member 21 and the female belt-like member 22 at a position corresponding to each of the side seal portions 13. With the cut 25, portions of the male engagement portion 21A and the female engagement portion 22A corresponding to the side seal portions 13 are almost removed. Since an unevenness of the male engagement portion 21A and the female engagement portion 22A is eliminated, the base film 10 can be favorably sealed at the side seal portions 13.

The base film 10 is sealed at the three sides thereof, i.e., the top seal portion 12 and the side seal portions 13, to define a containing space 14 therein. The containing space 14 can contain solids, powders, liquids or the like.

The base film 10 has an inner surface 10A on which the male belt-like member 21 and the female belt-like member 22 are heat-sealed.

The base film 10 is not particularly limited as long as being usable as a material for a packaging bag. Preferably, the thickness of the base film 10 is in a range from 10 μm to 200 μm.

When the thickness of the base film 10 is less than 10 μm, sealing strength and bag strength may be weakened. On the other hand, when the thickness of the base film 10 is more than 200 μm, the bag may be difficult to open.

The base film 10 may have a single-layered structure or a multi-layered structure.

The male belt-like member 21 includes a male belt-like base 21B like an elongated belt. The male engagement portion 21A projects from a surface of the male belt-like base 21B facing the containing space 14. The male engagement portion 21A is formed along the longitudinal direction of the male belt-like base 21B substantially at the center in the width direction of the male belt-like base 21B.

The female belt-like member 22 likewise includes a female belt-like base 22B. The female engagement portion 22A, which is in the form of a rib and is engageable with the male engagement portion 21A, projects from a surface of the female belt-like base 22B facing the containing space 14.

The width of each of the male belt-like base 21B and the female belt-like base 22B is preferably in a range from 2 mm to 50 mm, more preferably from 5 mm to 20 mm

When the width is less than 2 mm, a holdable portion may become small and difficult to hold. On the other hand, when the width is more than 50 mm, a zipper tape portion may become large relative to a bag, providing an unfavorable appearance.

The thickness of each of the male belt-like base 21B and the female belt-like base 22B is preferably in a range from 50 μm to 500 μm, more preferably from 100 μm to 200 μm.

An unsealing start position of the packaging bag 1 is only required to be closer to the top seal portion 12 apart from an engagement portion provided by the male engagement portion 21A and the female engagement portion 22A. A notch formed in the side seal portions 13 of the base film 10 or an unsealing tape provided near the male engagement portion 21A and the female engagement portion 22A will help unsealing the packaging bag 1.

Manufacturing Device of Packaging Bag

Next, a manufacturing device for manufacturing the packaging bag 1 will be described with reference to the attached drawings.

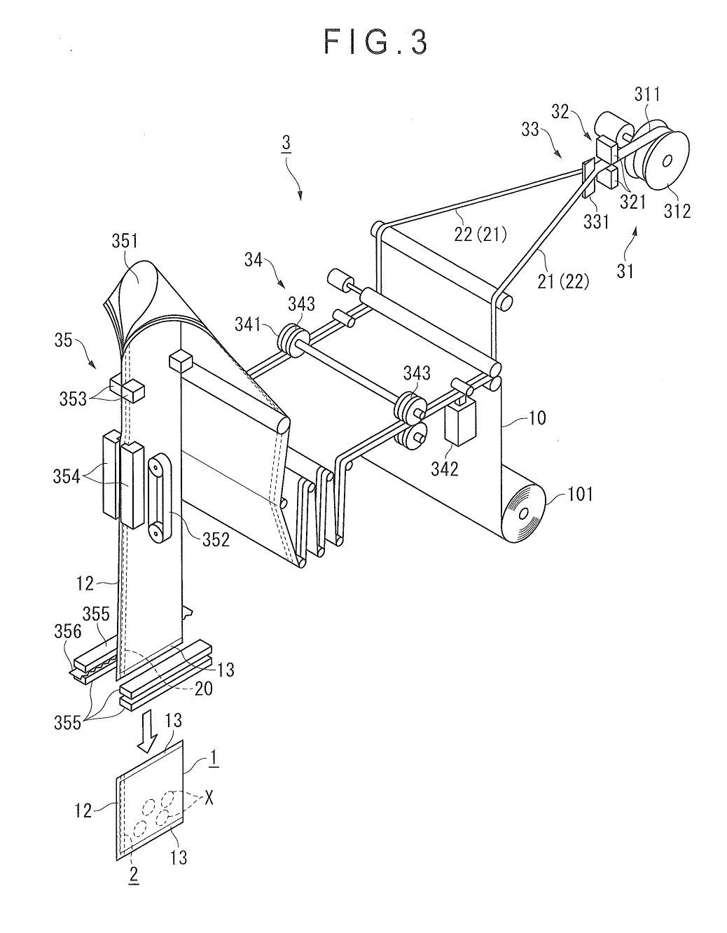

FIG. 3 is a perspective view showing a manufacturing device of a packaging bag. FIG. 4 is a perspective view showing a cut formed in a zipper tape member.

As shown in FIG. 3, a manufacturing device 3 is a so-called vertical-pillow device, and includes a tape feeder 31 (tape feeding unit) that feeds a zipper tape member 311, a puncher 32 (punching unit) that punches the zipper tape member 311 to form the cut 25 therein (see FIG. 4), a separator 33 (separating unit) that separates the zipper tape member 311 into the male belt-like member 21 (male tape) and the female belt-like member 22 (female tape), a zipper tape adhering device 34 (adhering unit) that adheres the male belt-like member 21 and the female belt-like member 22 to the base film 10, and a bag-manufacturing device 35 that forms the base film 10 into the packaging bag 1. After the manufacturing device 3, a filler (not shown) is provided to fill the manufactured packaging bag 1 with contents X in the next process.

As shown in FIG. 4, the zipper tape member 311 includes a tape 313 in the form of an elongated belt, from which the male engagement portion 21A and the female engagement portion 22A project in pairs. The male engagement portion 21A and the female engagement portion 22A are formed like ribs along the longitudinal direction of the tape 313. In other words, on a surface of the zipper tape member 311, the male belt-like member 21 and the female belt-like member 22 are arranged in parallel with each other in the width direction of the zipper tape member 311.

As shown in FIG. 3, a film-winding roll 312 with the zipper tape member 311 wound thereon is detachably mounted on the tape feeder 31 (tape feeding unit). The tape feeder 31 feeds the zipper tape member 311.

The zipper tape member 311 may be fed in any manner, for instance, in a continuous manner at a constant speed or in an intermittent manner.

As shown in FIG. 4, the puncher 32 (punching unit) includes a die 321. When the zipper tape member 311 is fed from the tape feeder 31, the die 321 of the puncher 32 punches the zipper tape member 311 to form the cuts 25. The zipper tape member 311 is punched at predetermined intervals in the feeding direction thereof at least at a position corresponding to the male engagement portion 21A and a position corresponding to the female engagement portion 22A.

In other words, the cuts 25 are formed at predetermined intervals corresponding to the positions of the side seal portions 13.

As long as at least the male engagement portion 21A and the female engagement portion 22A are removed, the operation of the puncher 32 is not limited to pressing. Further, in this exemplary embodiment, the puncher 32 is omittable. Still further, the male engagement portion 21A and the female engagement portion 22A are preferably punched together to form a single cut 25 as compared with an arrangement in which they are separately punched to form the respective cuts 25. With this arrangement, the structure of the die 321 for punching and the punching process can be simplified to perform the bag-manufacturing process with an improved efficiency.

As shown in FIG. 3, the separator 33 (separating unit) includes a cutting member 331.

When the cuts 25 are formed in the zipper tape member 311 fed from the tape feeder 31, using the cutting member 331, the separator 33 cuts the zipper tape member 311 between the male engagement portion 21A and the female engagement portion 22A (arranged in the width direction of the zipper tape member 311) to separate the zipper tape member 311 into the male belt-like member 21 having the male engagement portion 21A and the female belt-like member 22 having the female engagement portion 22A.

The cutting member 331 may be, for instance, a fixed blade or a rotary blade.

In consideration of positioning the male engagement portion 21A and the female engagement portion 22A in the following process, or the like, it is preferable to cut the zipper tape member 311 at the center between the male engagement portion 21A and the female engagement portion 22A in the width direction of the zipper tape member 311.

As shown in FIG. 3, the zipper tape adhering device 34 (adhering unit) includes a positioning guide portion 341 and a first heat seal portion 342.

The male belt-like member 21 and the female belt-like member 22 are positioned through the positioning guide portion 341 of the zipper tape adhering device 34. The male belt-like member 21 and the female belt-like member 22 are thus positioned on both sides of the base film 10 fed from a film-winding roll 101 relative to the feeding direction of the base film 10 (i.e., the longitudinal direction of the base film 10) such that the male belt-like member 21 and the female belt-like member 22 extend along both side edges of the base film 10, respectively. After being positioned, the male belt-like member 21 and the female belt-like member 22 are heat-sealed to the base film 10 through the first heat seal portion 342 of the zipper tape adhering device 34.

The positioning guide portion 341 exemplarily uses rollers 343 with grooves on circumferential surfaces thereof as shown in FIG. 3, the grooves corresponding the male engagement portion 21A and the female engagement portion 22A. However, the invention may employ any arrangement as long as the base film 10, the male belt-like member 21 and the female belt-like member 22 can be positioned while being fed.

Although the male belt-like member 21 and the female belt-like member 22 are exemplarily adhered to the base film 10 by heat-sealing, the male belt-like member 21 and the female belt-like member 22 may be adhered in various ways such as by seizing with ultrasonic waves and using an adhesive.

As shown in FIG. 3, the bag-manufacturing device 35 includes a cylindrical former 351 around which the base film 10 with the male belt-like member 21 and female belt-like member 22 (the zipper tape 2) fused thereon is wrapped, feed belts 352 located at the sides of the cylindrical former 351, an engagement member 353 that brings the male engagement portion 21A and the female engagement portion 22A into engagement with each other, seal bars 354 that heat-seal both side portions of the base film 10 together to form the top seal portion 12, side seal bars 355 that form the side seal portions 13 by heat-sealing, and a cutter 356 that cuts the base film 10 at a position corresponding to each of the side seal portions 13 to provide the packaging bag 1.

The cylindrical former 351 is formed hollow. The packaging bag 1 is filled with contents fed through an inner space of the cylindrical former 351.

When the base film 10 is wrapped around the cylindrical former 351 and both sides thereof are superposed on each other, the male engagement portion 21A and female engagement portion 22A are opposed to be engaged with each other through the engagement member 353.

Manufacturing Method of Packaging Bag

Next, description will be made on a method of manufacturing the packaging bag 1 using the manufacturing device 3.

The method of manufacturing the packaging bag 1 includes a tape-feeding step of feeding the zipper tape member 311, a punching step of punching the zipper tape member 311 to form the cut 25, a separating step of separating the zipper tape member 311 into the male belt-like member 21 and the female belt-like member 22 and engaging the male belt-like member 21 and the female belt-like member 22 with each other, an adhering step of adhering the zipper tape 2 to the base film 10, and a bag-manufacturing step of forming the packaging bag 1 from the base film 10.

In the tape-feeding step, the zipper tape member 311 is pulled out of the film-winding roll 312 and is fed. The zipper tape member 311 is subjected to the punching step.

In the punching step, the fed zipper tape member 311 is punched by the die 321 at predetermined intervals to form the cuts 25 therein.

Subsequently, in the separating step, the fed zipper tape member 311 is separated into the male belt-like member 21 and the female belt-like member 22 using the cutting member 331.

In the adhering step, the separated male belt-like member 21 and female belt-like member 22 are positioned on both sides of the fed base film 10 through the positioning guide portion 341 such that the male belt-like base 21B and the female belt-like base 22B are superposed on the sides of the base film 10, respectively. After the positioning, the male belt-like member 21 and female belt-like member 22 are heat-sealed to the base film 10 through the first heat seal portion 342.

Subsequently, in the bag-manufacturing step, the base film 10 is wrapped around the cylindrical former 351, and the male engagement portion 21A and the female engagement portion 22A are engaged with each other through the engagement member 353. Both side edges of the base film 10 superposed on each other are heat-sealed together through the seal bars 354 to form the top seal portion 12. The base film 10 is further heat-sealed in a direction orthogonal to the feeding direction of the base film 10 through the side seal bars 355 to form one of the side seal portions 13 to provide the packaging bag 1.

A filler (not shown) feeds the manufactured packaging bag 1 with a predetermined amount of contents. The packaging bag 1 is then heat-sealed in the direction orthogonal to the feeding direction of the base film 10 through the side seal bars 355 to form the other side seal portion 13 so that the contents are enclosed in the packaging bag 1. Each of the side seal portions 13 is cut at the intermediate position thereof, so that the packaging bag 1 is filled with the contents X.

Advantages of First Exemplary Embodiment

In the above exemplary embodiment, before being adhered to the base film 10, the zipper tape member 311 having the pair of male engagement portion 21A and female engagement portion 22A is separated into the male belt-like member 21 and the female belt-like member 22.

With this arrangement, it is possible to prevent a length difference or a tension difference between the fed male belt-like member 21 and female belt-like member 22, so that the packaging bag 1 can be easily manufactured without problems such as creases formed on the base film 10 resulting from the adhesion and adhesion failure of the zipper tape 2.

In the separating step, the zipper tape member 311 is cut using the cutting member 331 to be separated.

With this arrangement, the zipper tape member 311 can be easily and reliably separated at a desired position.

The zipper tape member 311 is subjected to the punching step at the predetermined intervals, i.e., intervals corresponding to the side seal portions 13, to punch and remove at least the male engagement portion 21A and the female engagement portion 22A.

With this arrangement, even without performing a claw-crushing step to heat and crush the male engagement portion 21A and female engagement portion 22A of the zipper tape member 311, it is possible to heat-seal the base film 10 at the side seal portions 13 without a fusing failure resulting from an unevenness of the male engagement portion 21A and the female engagement portion 22A. The unevenness can be easily eliminated by the punching step as compared with the claw-crushing step for the zipper tape member 311, thereby improving manufacturing efficiency.

### Second Exemplary Embodiment

Next, a second exemplary embodiment of the invention will be described with reference to the attached drawings.

The second exemplary embodiment also relates to a vertical-pillow bag-manufacturing method as well as the first exemplary embodiment.

Incidentally, in the second exemplary embodiment, like reference numerals are attached to the components same as or similar to those in the first exemplary embodiment, thereby omitting or simplifying the explanation thereof.

Manufacturing Device of Packaging Bag

Description will be made below on a manufacturing device for manufacturing the packaging bag 1.

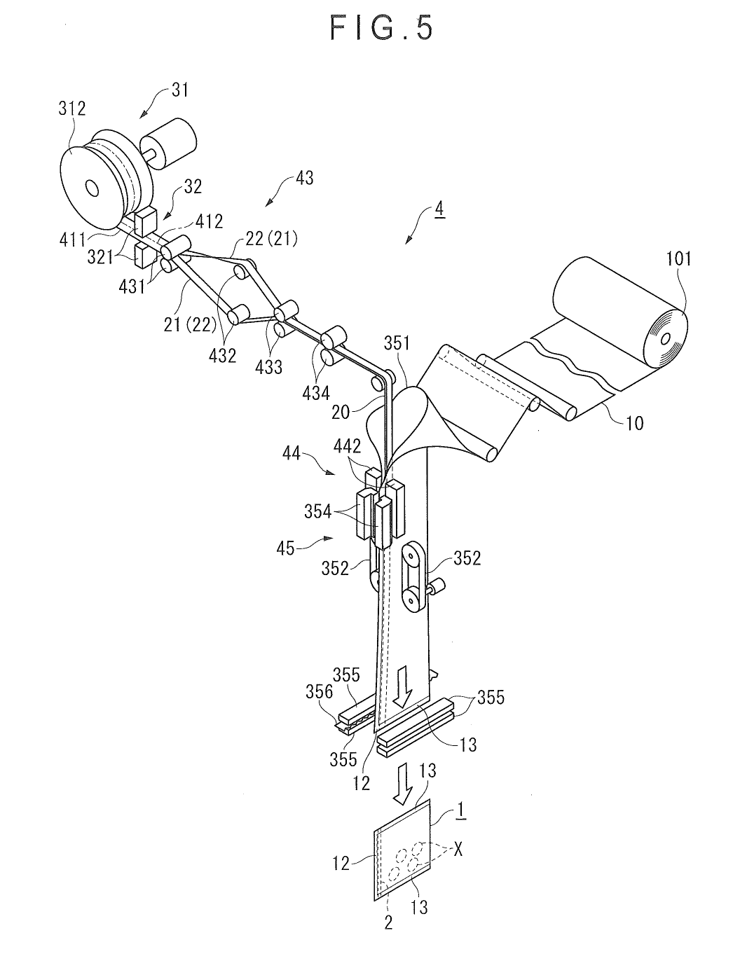

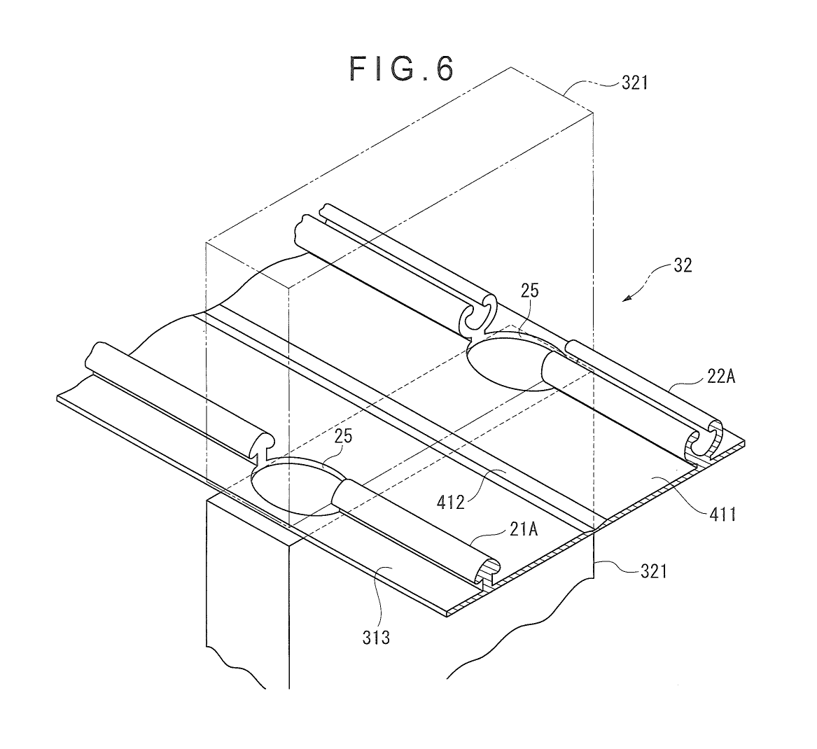

FIG. 5 is a perspective view showing a manufacturing device of a packaging bag according to the second exemplary embodiment. FIG. 6 is a perspective view showing a cut formed in a zipper tape member.

As shown in FIG. 5, a manufacturing device 4 has the same structure as that of the first exemplary embodiment except for the arrangement of a separator.

Additionally, as shown in FIG. 6, a zipper tape member 411 is provided with a thin portion 412 formed in the longitudinal direction thereof between the male engagement portion 21A and female engagement portion 22A of the zipper tape member 311 according to the first exemplary embodiment. The thin portion 412 may be replaced with a so-called perforated portion in the form of a dotted cut line (i.e., perforations), or may be used in combination with the perforated portion.

As shown in FIG. 5, a separator 43 (separating unit) splits the zipper tape member 411 at the thin portion 412 to separate the zipper tape member 411.

Specifically, the separator 43 includes a pair of holding rollers 431 between which the zipper tape member 411 is held, splitting rollers 432 that are located at the downstream of the holding rollers 431 in the feeding direction of the zipper tape member 411 and onto which the separated male belt-like member 21 and female belt-like member 22 are set, respectively, positioning rollers 433 that are located at the downstream side of the splitting rollers 432 and between which the male belt-like member 21 and the female belt-like member 22 are set such that the male engagement portion 21A and the female engagement portion 22A face each other, and a pair of engagement rollers 434 that are located at the downstream side of the positioning rollers 433 to bring the male engagement portion 21A and the female engagement portion 22A into engagement with each other.

The splitting rollers 432 are located at both sides of the zipper tape member 411 in the longitudinal direction with a space therebetween such that the splitting rollers 432 exhibit opposite tensions in the thickness direction of the zipper tape member 411 to split the zipper tape member 411 at the thin portion 412 into the male belt-like member 21 and the female belt-like member 22.

Incidentally, the split male belt-like member 21 and female belt-like member 22 are set on the splitting rollers 432, respectively, while one of the male belt-like member 21 and the female belt-like member 22 is inverted so that the male engagement portion 21A and the female engagement portion 22A face each other.

Although only one of the male belt-like member 21 and the female belt-like member 22 is exemplarily inverted, both of the male belt-like member 21 and the female belt-like member 22 may be twisted by 90 degrees in the opposite directions so that the male engagement portion 21A and the female engagement portion 22A face each other. With this arrangement, since the same torsion acts on both the male belt-like member 21 and the female belt-like member 22, there is no difference in a fed state between the male belt-like member 21 and the female belt-like member 22, and thus the zipper tape 2 can be favorably adhered.

Incidentally, while being unengaged with each other, the male belt-like member 21 and the female belt-like member 22 may be adhered to the base film 10 through a zipper tape adhering device 44 (adhering unit) in the following step. Incidentally, when the male belt-like member 21 and the female belt-like member 22 are engaged after being adhered to the base film 10 or when the base film 10 is side-sealed while the male belt-like member 21 and the female belt-like member 22 are unengaged with each other, a half-folded tape or the like needs to be incorporated.

As shown in FIG. 5, the zipper tape adhering device 44 (adhering unit) includes a second heat seal portion 442.

The base film 10 fed from the film-winding roll 101 is wrapped around the cylindrical former 351 of a bag-manufacturing device 45, and both sides of the base film 10 relative to the feeding direction are superposed on each other. In the zipper tape adhering device 44, the zipper tape 2 fed from the separator 43 is interposed between such superposed portions of the base film 10, and is heat-sealed to the base film 10 by the second heat seal portion 442.

Although the zipper tape 2 is exemplarily adhered to the base film 10 by heat-sealing, the zipper tape 2 may be adhered in various ways such as by seizing with ultrasonic waves and using an adhesive in the same manner as in the zipper tape adhering device 34.

The bag-manufacturing device 45 includes the cylindrical former 351 around which the base film 10 is wrapped, the feed belts 352 located at the sides of the cylindrical former 351, the seal bars 354 that heat-seal both side portions of the base film 10 together to form the top seal portion 12, the side seal bars 355 that form the side seal portions 13 by heat-sealing, and the cutter 356 that cuts the base film 10 at a position corresponding to each of the side seal portions 13 to provide the packaging bag 1.

Manufacturing Method of Packaging Bag

Next, description will be made on a method of manufacturing the packaging bag 1 using the manufacturing device 4.

According to the second exemplary embodiment, when the zipper tape member 411 is fed and punched, the zipper tape member 411 is split at the thin portion 412 in the separating step to be separated into the male belt-like member 21 and the female belt-like member 22. The pair of male engagement portion 21A and female engagement portion 22A are engaged with each other to provide the zipper tape 2.

The zipper tape 2 is adhered to both side portions of the base film 10 wrapped around the cylindrical former 351 in the adhering step for manufacturing a bag in the same manner as in the first exemplary embodiment.

Advantages of Second Exemplary Embodiment

This exemplary embodiment provides the same advantages as those of the first exemplary embodiment. Additionally, since the separator 43 includes the splitting rollers 432 that split the zipper tape member 411 at the thin portion 412 thereof, as compared with the arrangement of the first exemplary embodiment using the cutting member 331, the arrangement of this exemplary embodiment does not require maintenance accompanying replacement of components, which results in an improvement in manufacturability.

### Third Exemplary Embodiment

Next, a third exemplary embodiment of the invention will be described with reference to the attached drawings.

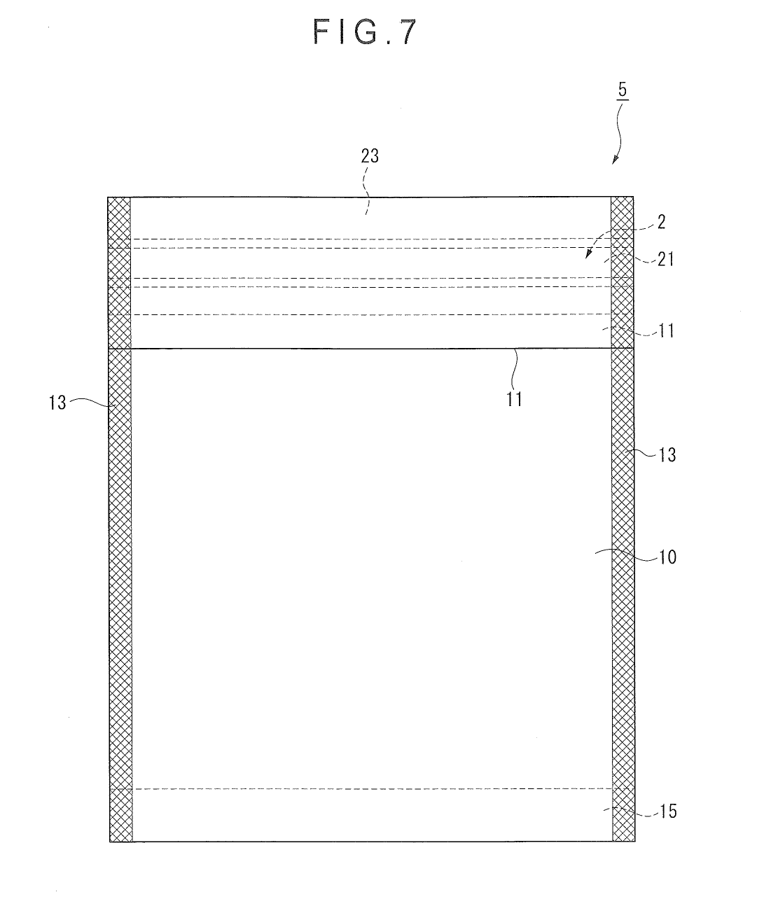

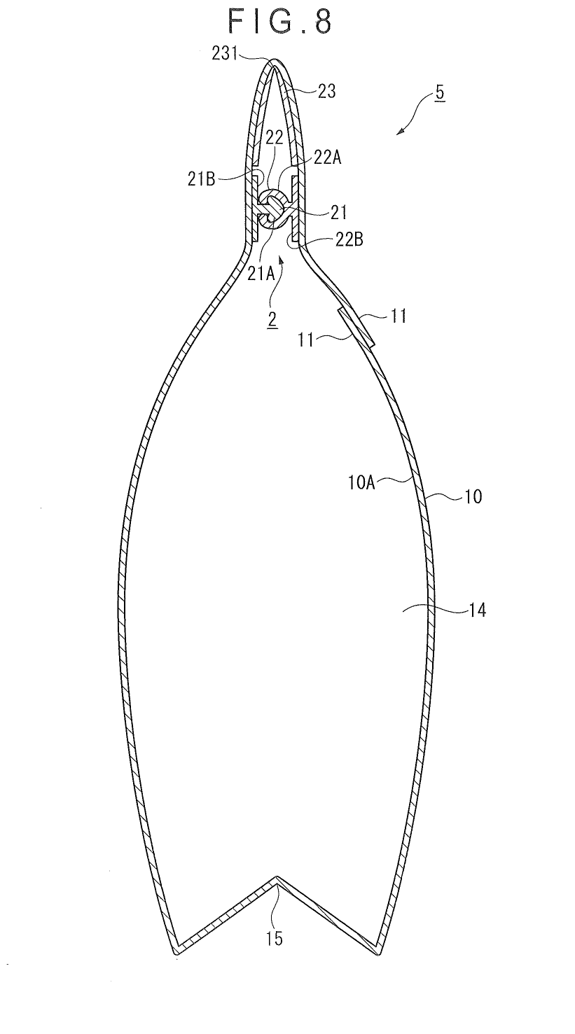

FIG. 7 is a plan view showing a packaging bag according to the third exemplary embodiment. FIG. 8 is a cross-sectional view showing the packaging bag according to the third exemplary embodiment.

Arrangement of Packaging Bag

As shown in FIGS. 7 and 8, a packaging bag 5 includes a sheet of base film 10, the male belt-like member 21 including the male engagement portion 21A, the female belt-like member 22 including the female engagement portion 22A, and a bendable member 23 being located between the male belt-like member 21 and the female belt-like member 22 and having a thin bendable portion 231 that is located at the center in the width direction of the bendable member 23 and is bent so that the male engagement portion 21A and the female engagement portion 22A are engaged with each other. The male belt-like member 21, the female belt-like member 22 and the bendable member 23 are separately provided to the base film 10, and are adhered to the base film 10 side by side at predetermined intervals. The male belt-like member 21 and the female belt-like member 22 provide the zipper tape 2.

The base film 10 includes a lining seal portion in which the first base end 11 is lined with the second base end 11.

The side seal portions 13 are provided by heat-sealing both side edge portions of the base film 10. The male belt-like member 21 and the female belt-like member 22 extend between the side seal portions 13.

The lining seal portion and the side seal portions 13 define the containing space 14 of the base film 10. A gusset 15 is provided to the bottom of the base film 10.

Manufacturing Device of Packaging Bag

Next, a manufacturing device for manufacturing the packaging bag 5 will be described with reference to the attached drawings.

The third exemplary embodiment relates to a rotary-drum bag-manufacturing method.

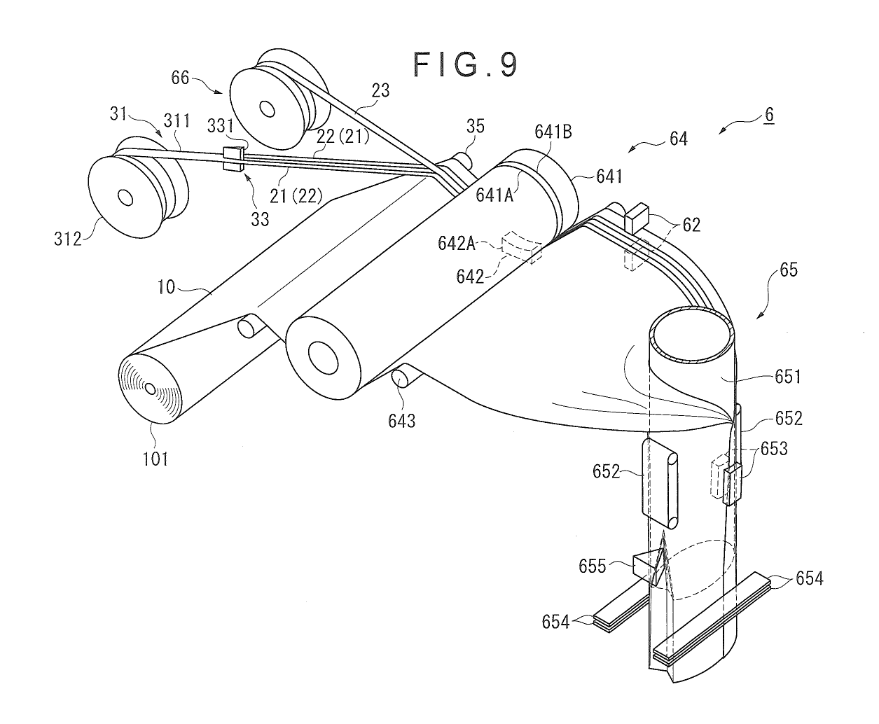

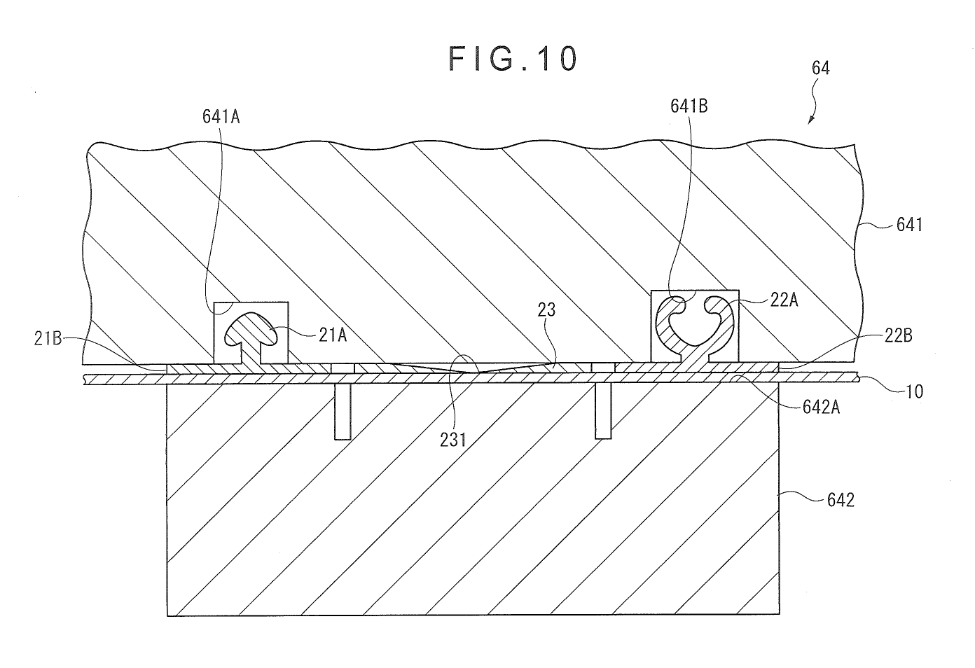

FIG. 9 is a perspective view showing a manufacturing device of a packaging bag. FIG. 10 is a cross-sectional view showing a state where the zipper tape is heat-sealed to the base film.

Incidentally, in the third exemplary embodiment, like reference numerals are attached to the components same as or similar to those in the first and second exemplary embodiments, thereby omitting or simplifying the explanation thereof. The third exemplary embodiment uses the same zipper tape member 311 as in the first exemplary embodiment.

As shown in FIG. 9, a manufacturing device 6 includes the tape feeder 31 that feeds the zipper tape member 311, the separator 33 that separates the zipper tape member 311 into the male belt-like member 21 and the female belt-like member 22, a. zipper tape adhering device 64 (adhering unit) that adheres the male belt-like member 21 and the female belt-like member 22 to the base film 10, claw-crushing bars 62 that crush the male engagement portion 21A and the female engagement portion 22A at every predetermined interval, a bag-manufacturing device 65 that forms the packaging bag 5 from the base film 10, and a bendable-member feeder 66 that feeds the bendable member 23. 643 denotes a guide roller.

As shown in FIGS. 9 and 10, the zipper tape adhering device 64 (adhering unit) includes a substantially columnar rotary drum 641 being rotated by a driving source (not shown), and a seal bar 642 having a fusing surface 642A curved in conformity with the circumferential shape of the rotary drum 641.

The rotary drum 641 is provided with a first groove 641A that guides the male engagement portion 21A therein, and a second groove 641B that guides the female engagement portion 22A therein, the first and second grooves 641A and 641B being formed along the circumferential direction of the rotary drum 641.

The first groove 641A has a substantially rectangular cross section large enough to accommodate the male belt-like member 21 therein. The second groove 641B has a substantially rectangular cross section large enough to accommodate the female belt-like member 22 therein. The bottom surface of each of the grooves 641A and 641B is substantially parallel to the circumferential surface of the rotary drum 641. The opposite lateral surfaces of the groove 641A are formed to have substantially the same length as the projecting length of the male belt-like member 21 and the opposite lateral surfaces of the groove 641B are formed to have substantially the same length as the projecting length of the female belt-like member 22.

The first and second grooves 641A and 641B are provided in a manner capable of guiding the male engagement portion 21A and the female engagement portion 22A therein while the bendable member 23 is located between the male belt-like base 21B and the female belt-like base 22B at a predetermined space from each thereof so that the bendable portion 231 of the bendable member 23 allows engagement between the male engagement portion 21A and the female engagement portion 22A.

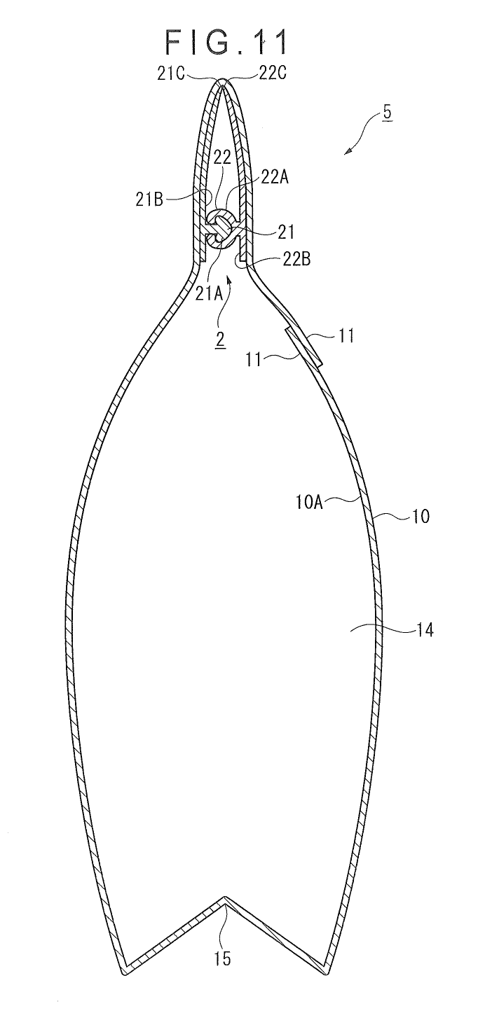

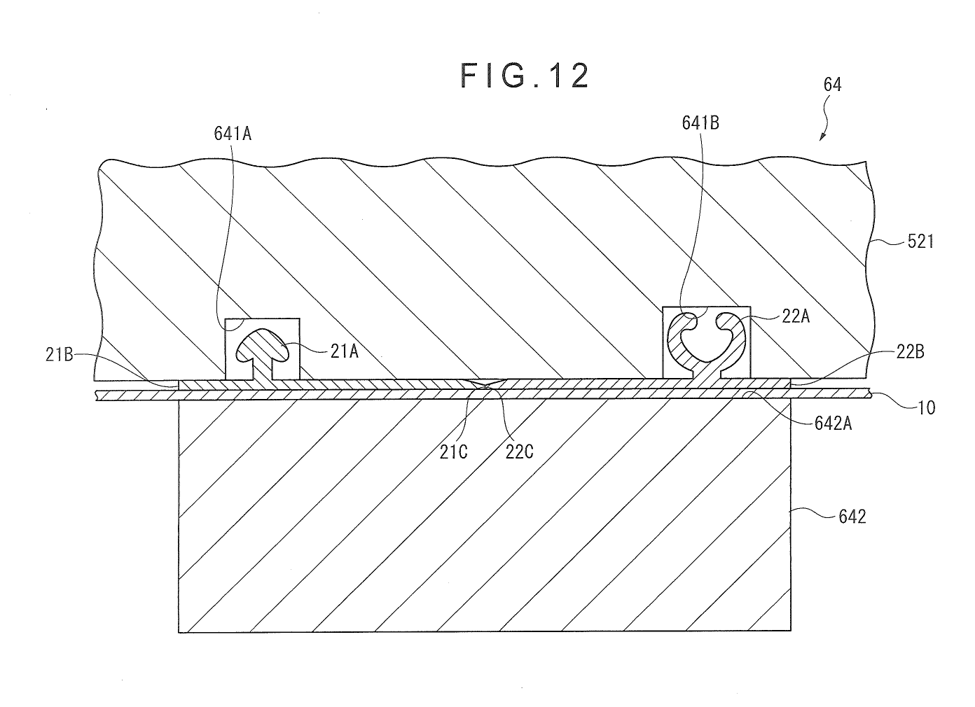

Instead of the above arrangement in which the bendable member 23 is provided, as shown in FIGS. 11 and 12, the male engagement portion 21A and the female engagement portion 22A may be guided while an edge 21C of the male belt-like base 21B and an edge 22C of the female belt-like base 22B are substantially abutted against each other. With the arrangement shown in FIGS. 11 and 12, the male belt-like base 21B and the female belt-like base 22B can be easily positioned, so that a reliable reengagement between the male belt-like base 21B and the female belt-like base 22B after unsealing can be easily realized. In addition to the above arrangement, any arrangement is employable as long as a reliable reengagement after unsealing is realized. For instance, an additional step may be provided to engage the male engagement portion 21A and the female engagement portion 22A with each other during the bag-manufacturing step.

The rotary drum 641 may be supported by a support such that the axial direction of the rotary drum 641 becomes horizontal. With this arrangement, the male belt-like member 21 and the female belt-like member 22 can be easily positioned to respective predetermined positions on the base film 10.

As shown in FIG. 9, a pair of claw-crushing bars 62 are opposed to each other with the zipper tape 2 interposed therebetween. The pair of claw-crushing bars 62 crush and melt-flatten the male engagement portion 21A and the female engagement portion 22A at every predetermined interval in the feeding direction of the zipper tape 2. The melt-flattened claw-crushed portion is located at a position corresponding to each of the side seal portions 13 of the packaging bag 5 in the same manner as the cut 25 in the first and second exemplary embodiments.

The bag-manufacturing device 65 includes a cylindrical former 651 around which the base film 10 fused with the zipper tape 2 is wrapped, feed belts 652 located at the sides of the cylindrical former 651, seal bars 653 that fuse both the base ends 11 of the base film 10 to each other to form the lining seal portion, side seal bars 654 that form the side seal portions 13, and a triangle plate 655 that forms the gusset 15, and a cutter (not shown) that cuts the base film 10 at a position corresponding to each of the side seal portions 13 to provide the packaging bag 5.

Manufacturing Method of Packaging Bag

Description will be made on a method of manufacturing the packaging bag 5 using the manufacturing device 6.

A method of manufacturing the packaging bag 5 includes a tape-feeding step of feeding the zipper tape member 311, a separating step of separating the zipper tape member 311 into the male belt-like member 21 and the female belt-like member 22, an adhering step of adhering the zipper tape 2 to the base film 10, a claw-crushing step of crushing the male engagement portion 21A and the female engagement portion 22A at every predetermined interval, and a bag-manufacturing step of forming the packaging bag 5 from the base film 10.

The zipper tape member 311 is pulled out of the film-winding roll 312 in the tape-feeding step, and is separated into the male belt-like member 21 and the female belt-like member 22 by the cutting member 331 in the separating step.

While being superposed on the base film 10 pulled out of the film-winding roll 101, the male belt-like member 21 and the female belt-like member 22 are fed to the zipper tape adhering device 64.

In the adhering step, during the rotation of the rotary drum 641 of the zipper tape adhering device 64, the male belt-like member 21 and the female belt-like member 22 are continuously fed along with the base film 10, on which the male belt-like member 21 and the female belt-like member 22 are superposed, while being guided by the grooves 641A and 641B of the rotary drum 641, respectively.

Simultaneously, the male belt-like member 21 and the female belt-like member 22 are adhered to a sheet of base film 10 by pressing the base film 10 with the seal bar 642 having the fusing surface 642A curved in conformity with the circumferential surface of the rotary drum 641.

The rotation speed of the rotary drum 641 for continuously feeding the male belt-like member 21, the female belt-like member 22 and the base film 10 is preferably in a range from 5 m/min to 40 m/min, more preferably from 10 m/min to 30 m/min

When the speed is less than 5 m/min, productivity may be reduced to increase costs. On the other hand, when the speed exceeds 40 m/min, sealing strength may become unstable.

Thus, the base film 10 with the zipper tape 2 fused thereto is fed to the claw-crushing bars 62 without engagement between the male belt-like member 21 and the female belt-like member 22.

In the claw-crushing step, the claw-crushing bars 62 crush the male engagement portion 21A and female engagement portion 22A of the zipper tape 2 to be melt-flattened. The base film 10 with the zipper tape 2 fused thereto is further fed to the bag-manufacturing device 65.

In the bag-manufacturing step, the base film 10 is fed downward by the feed belts 652 while being wrapped around the cylindrical former 651. Here, the base film 10 is fed such that the portion melt-flattened by the claw-crushing bars 62 is aligned with each of the side seal portions 13. The lining seal portion is formed by the seal bars 653, and the gusset 15 is formed at a position corresponding to the bag bottom by the triangle plate 655.

The side seal bars 654 form one of the side seal portions 13. After the contents are fed through the inner space of the cylindrical former 651, the side seal bars 654 form the other side seal portion 13. The base film 10 is cut at a position corresponding to the other side seal portion 13 to provide the packaging bag 5.

Advantages of Third Exemplary Embodiment

In the third exemplary embodiment as well as in the first and second exemplary embodiments, the male belt-like member 21 and the female belt-like member 22 can be fed without any length difference therebetween. Thus, by simply separating the zipper tape member 311, the packaging bag 5 capable of easy engagement and unsealing can be manufactured without problems such as creases on the base film 10 resulting from the adhesion and adhesion failure of the zipper tape 2.

### Fourth Exemplary Embodiment

Next, a fourth exemplary embodiment of the invention will be described with reference to the attached drawings.

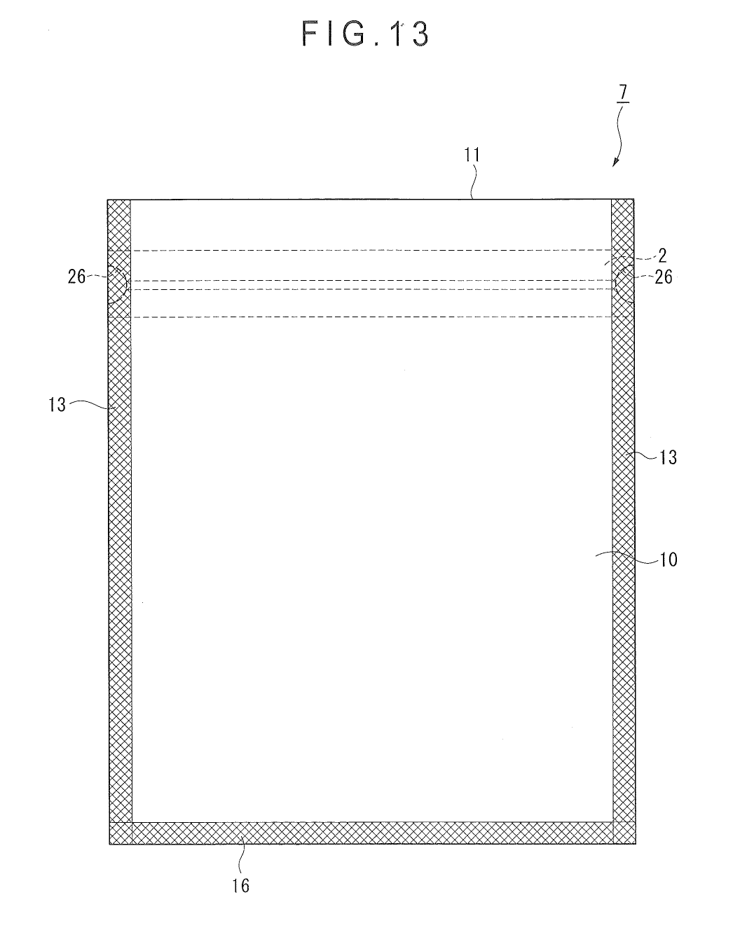

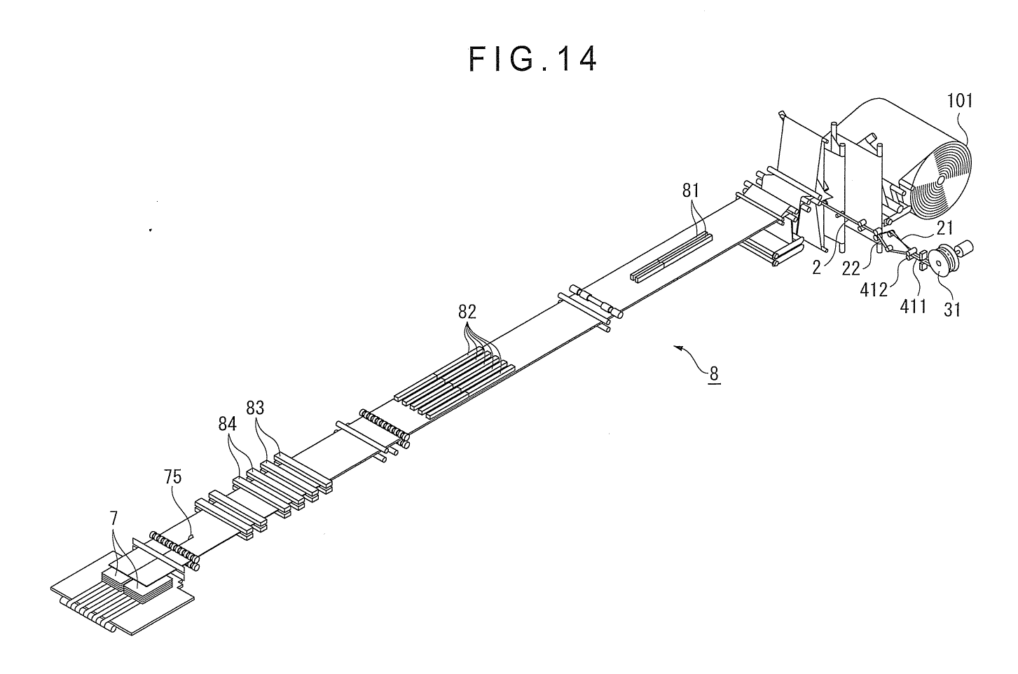

FIG. 13 is a plan view showing a packaging bag according to the fourth exemplary embodiment. FIG. 14 shows a manufacturing device of a packaging bag according to the fourth exemplary embodiment.

As shown in FIG. 13, a packaging bag 7 includes a sheet of base film 10 (packaging bag film), the male belt-like member 21 (male tape) including the male engagement portion 21A, and the female belt-like member 22 (female tape) including the female engagement portion 22A, the male belt-like member 21 and female belt-like member 22 being adhered to the base film 10, in the same manner as in the first exemplary embodiment.

The base film 10 includes the first and second base ends 11 and the bottom seal portion 16 provided by superposing the first base end 11 on the second base end 11.

The side seal portions 13 are provided by heat-sealing both side edge portions of the base film 10. The male belt-like member 21 and the female belt-like member 22 extend between the side seal portions 13.

A claw-crushed portion 26 is provided to the male belt-like member 21 and the female belt-like member 22A at a position corresponding to each of the side seal portions 13, in the same manner as in the third exemplary embodiment.

The base film 10 is sealed at the three sides thereof, i.e., the bottom seal portion 16 and the side seal portions 13, to form a containing space therein.

FIG. 14 shows an example of a manufacturing device 8 usable for such a three-side-sealing bag-manufacturing method. In the manufacturing device 8, in advance, the zipper tape member 411 fed from the tape feeder 31 is split into the male belt-like member 21 (22) and the female belt-like member 22 (21) at the thin portion 412 in the same manner as in the second exemplary embodiment, and the male belt-like member 21 (22) and the female belt-like member 22 (21) are engaged with each other to form the zipper tape 2 in the same manner as in the third exemplary embodiment. The manufacturing device 8 includes a zipper tape adhering device 81 (adhering unit) that heat-seals the already-engaged zipper tape 2 to the base film 10, seal bars 82 that form the bottom seal portion 16, claw-crushing bars 83, side seal bars 84 that form the side seal portions 13, and a cutter 75 that cuts each of the side seal portions 13 at the intermediate position thereof to provide the package bag 7 heat-sealed at the three sides, i.e., the bottom seal portion 16 and the side seal portions 13.

With this arrangement, it is also possible to provide the same advantages as those of the first exemplary embodiment. Although the above description of this exemplary embodiment relates to a three-side-sealing bag-manufacturing method of heat-sealing the bottom seal portion 16 and the side seal portions 13, the invention may be applied to a three-side-sealing bag-manufacturing method of heat-sealing the top seal portion and the side seal portions 13.

### Modifications

The scope of the invention is not limited to the above-described exemplary embodiments but also includes modifications and improvements as long as an object of the invention can be achieved.

Although contents are automatically fed to the packaging bag 1, 5 or 7 in the process of manufacturing the packaging bag in the above exemplary embodiments, the arrangement for manufacturing the packaging bag may be modified depending on contents to be fed. For instance, the packaging bag may be manufactured with an opening formed in a part thereof so that contents are fed to the packaging bag through the opening and then the opening is heat-sealed to close the packaging bag. Alternatively, for instance, the packaging bag can be closed not by heat-sealing but using a zipper tape in the same manner as a duvet cover or the like.

The invention is applicable to a three-side-sealing bag-manufacturing method of heat-sealing portions corresponding to the side surfaces and bottom surface of a packaging bag, a three-side-sealing bag-manufacturing method of heat-sealing portions corresponding to the side surfaces and opening surface of a packaging bag, and a packaging bag having side surfaces and bottom surface provided with gussets.

Although the zipper tape member 311 or 411 is separated into the male belt-like member 21 and the female belt-like member 22 after the cut 25 is formed in the zipper tape member 311 or 411, the arrangement may be appropriately modified depending on a bag manufacturing method. For instance, the cut 25 may be formed in each of the male belt-like member 21 and the female belt-like member 22 separated from the zipper tape member 311 or 411, or the cut 25 is provided to the already-engaged zipper tape 2 before the zipper tape 2 is adhered to the base film 10. Incidentally, the cut 25 is preferably provided to the zipper tape member 311 or 411 before the separating step in consideration of interference with other portions, or the like.

The invention is applicable to a variety of bag-manufacturing methods such as a vertical-pillow method as described in the first and second exemplary embodiments, a rotary-drum method as described in the third exemplary embodiment, a three-side-sealing bag-manufacturing method as described in the fourth exemplary embodiment, and a four-side-sealing bag-manufacturing method.

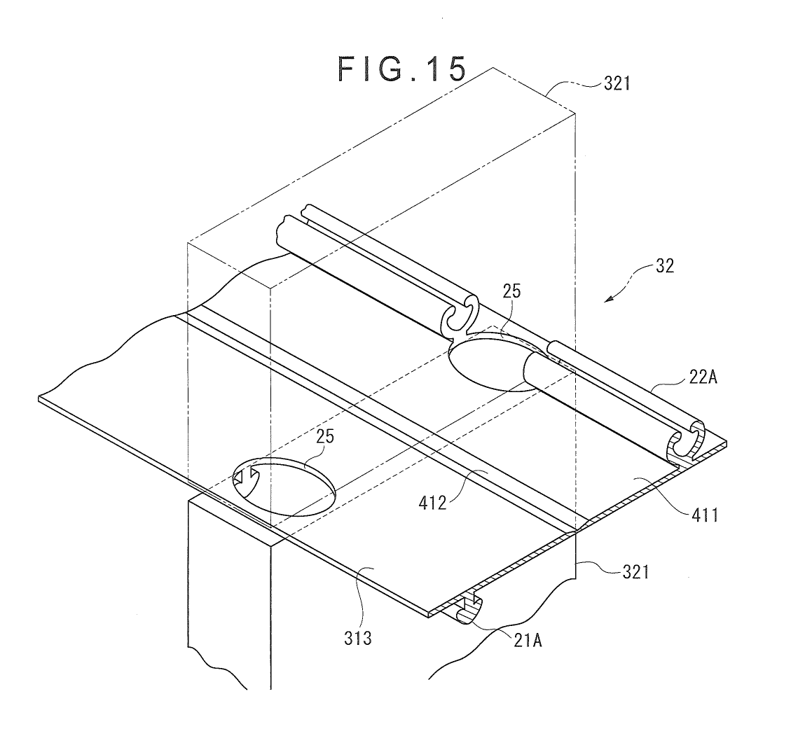

Although the male engagement portion 21A and the female engagement portion 22A are exemplarily arranged on a surface of the zipper tape member 311 or 411 (the same surface) in parallel with each other in the width direction, as shown in FIG. 15, the male engagement portion 21A and the female engagement portion 22A may be respectively provided on both surfaces of the zipper tape member 311 or 411 (different surfaces) in the width direction.

With this arrangement, it is not necessary to invert the separated male engagement portion 21A and female engagement portion 22A to face each other, so that manufacturability can be improved.

Specific arrangements, configuration and the like in implementing the invention may be modified to other arrangements and the like as long as the object of the invention can be achieved.

1. A method of manufacturing a zipper packaging bag, the zipper packaging bag being manufactured by adhering to a packaging bag film a zipper tape comprising a pair of male engagement portion and female engagement portion that are detachably engageable with each other to provide an engagement portion, the method comprising:
feeding a zipper tape member comprising an elongated belt-like tape on which the pair of male engagement portion and female engagement portion are formed along a longitudinal direction of the zipper tape member;
separating the fed zipper tape member in a width direction of the zipper tape member into the male engagement portion and the female engagement portion to provide a male tape forming the male engagement portion and a female tape forming the female engagement portion; and
adhering the male tape and the female tape to the packaging bag film.

2. The method according to claim 1, wherein
the fed zipper tape member is separated using a cutting member.

3. The method according to claim 1, wherein
the zipper tape member comprises at least one of a thin portion formed between the male engagement portion and the female engagement portion along the longitudinal direction of the zipper tape member and a perforated portion in a shape of a dotted cut line, and
the zipper tape member is separated by applying opposite tensions in a thickness direction of the zipper tape member to both sides of the zipper tape member relative to the longitudinal direction of the zipper tape member, respectively, so that the zipper tape member is split at least at one of the thin portion and the perforated portion.

4. The method according to claim 1, further comprising
punching the zipper tape member or the male tape and the female tape at predetermined intervals in a feeding direction of the zipper tape member at least at a position corresponding to the male engagement portion and a position corresponding to the female engagement portion.

5. The method according to claim 1, wherein
the male tape and the female tape are adhered to the packaging bag film while the male engagement portion and the female engagement portion are engaged with each other.

6. A manufacturing device of a zipper packaging bag, the zipper packaging bag being manufactured by adhering to a packaging bag film a zipper tape comprising a pair of male engagement portion and female engagement portion that are detachably engageable with each other to provide an engagement portion, the manufacturing device comprising:
a tape feeding unit configured to feed a zipper tape member at one end of the zipper tape member in a longitudinal direction of the zipper tape member, the zipper tape member comprising an elongated belt-like tape on which the pair of male engagement portion and female engagement portion are formed along the longitudinal direction;
a separating unit configured to separate the fed zipper tape member in a width direction of the zipper tape member into the male engagement portion and the female engagement portion to provide a male tape forming the male engagement portion and a female tape forming the female engagement portion; and
an adhering unit configured to adhere the male tape and the female tape to the packaging bag film.
